(19) United States
(12) Patent Application Publication
(10) Pub. No.: US 2014/0297953 A1
(43) Pub. Date: Oct. 2, 2014

(54) Removable Storage Device Identity and Configuration Information

(71) Applicant: Microsoft Corporation, (US)

(72) Inventors: Kyle T. Beck, Redmond, WA (US); Jeremy Aaron Kent, Seattle, WA (US); Yadriel Gonzalez Perez, Redmond, WA (US); Arun Gurunathan, Bellevue, WA (US); Roger Wynn, Redmond, WA (US); Sivaramakrishna Mopati, Issaquah, WA (US); Jared Matthew Krinke, Kirkland, WA (US)

(73) Assignee: Microsoft Corporation, Redmond, WA (US)

(21) Appl. No.: 13/854,109

(22) Filed: Mar. 31, 2013

(51) Int. Cl. G06F 3/06

(52) U.S. Cl. CPC G06F 3/0629; G06F 3/0679; G06F 3/0608
USPC 711/115

(57) ABSTRACT

In embodiments of removable storage device identity and configuration information, a removable storage device is accessible by device applications while connected to a computing device, such as to access application data. A device manager can identify one or more storage volumes on the removable storage device while the removable storage device is connected to the computing device. A storage volume may be previously identified as a storage location for another computing device when the removable storage device is connected to the other computing device. The device manager can also determine whether at least one of the storage volumes is associated with a user of the computing device if the storage volume is identified on the removable storage device, and then add the storage volume to a library of storage locations for the computing device at the identified storage location that is the same for the other computing device.

### BACKGROUND

Many types of devices, such as computing devices, mobile phones, and/or tablet devices are designed to use a removable storage device that can be inserted in any of the various types of devices and used as extended data storage. A common removable storage device is any of the various types of secure digital (SD) cards that are non-volatile memory and may be used in mobile phones, digital cameras, tablet devices, and/or other computing devices.

A removable storage device may be divided into more than one storage volume, such as for dedicated use by more than one application and/or users of the various computing devices. However, multiple volumes on a removable storage device cannot be uniquely identified in a consistent manner across the various computing devices of a user, nor can they be associated with a particular user. For example, storage volumes that are identified by location on a removable storage device may be added to a library of storage locations on a first computing device of a user. If the user then connects or inserts the removable storage device into a second computing device (on which the user is signed-on with the same user account), the second computing device would not be able to determine that the storage volumes on the removable storage device were previously configured for the user. Similarly, if another removable storage device is connected or inserted in the first computing device of the user, the first computing device would not be able to distinguish the other removable storage device from the original removable storage device.

The problem of identifying storage volumes is not specific to just multiple storage volumes on one storage device, or even specific to removable storage devices. A single storage volume on a removable device also cannot be uniquely identified in a consistent manner across multiple computing devices. Similarly, even a fixed storage device, such as a computer hard drive, will not be identified the same when removed from one computing device and installed in another computer.

One technique to identify a storage device, a removable storage device, and/or storage volumes on a removable or other storage device is by drive letters. However, the drive letters are not consistent across the various computing devices of a user, and the drive letters change based on what is currently connected to a computing device. The name of a storage device may also be used for identification of the storage device. However, two devices from the same manufacturer may have the same name and be indistinguishable to a computing device, and storage volumes on a removable or other storage device cannot be differentiated by a name or other identifier.

### SUMMARY

This Summary introduces features and concepts of removable storage device identity and configuration information, which is further described below in the Detailed Description and/or shown in the Figures. This Summary should not be considered to describe essential features of the claimed subject matter, nor used to determine or limit the scope of the claimed subject matter.

In embodiments of removable storage device identity and configuration information, a removable storage device is accessible by device applications while connected to a computing device, such as to access application data. A device manager can identify one or more storage volumes on the removable storage device while the removable storage device is connected to the computing device. A storage volume may be previously identified as a storage location for another computing device when the removable storage device is connected to the other computing device. The device manager can also determine whether at least one of the storage volumes is associated with a user of the computing device if the storage volume is identified on the removable storage device, and then add the storage volume to a library of storage locations for the computing device at the identified storage location that is the same for the other computing device.

In implementations, each of the storage volumes on the removable storage device are distinctly identified as separate storage volumes, and may have been previously configured on the removable storage device and associated with the user while the removable storage device is connected to the other computing device. Alternatively, the device manager can generate a distinct identifier for each of the storage volumes on the removable storage device if the storage volumes have not been previously identified, and write each of the distinct identifiers to the respective storage volumes on the removable storage device. A first instance of a device application on the computing device can access application data that is maintained by the storage volume of the removable storage device at an identified storage location. Additionally, a second instance of the device application on another computing device can access the application data at the identified storage location while the removable storage device is connected to the other computing device.

In implementations, the device manager can associate one or more of the storage volumes on the removable storage device with the user of the computing device, and write configuration information for each of the storage volumes to the removable storage device. A system indexer can also write a search index for each of the storage volumes to the removable storage device, where the search index is accessible by the system indexer to search the application data while the removable storage device is connected to the computing device. The search index is also accessible by a system indexer of another computing device while the removable storage device is connected to the other computing device.

In implementations, the device manager can detect the removable storage device and automatically initiate to determine whether the storage volumes are configured on the removable storage device and whether at least one of the storage volumes is associated with the user of the computing device. Alternatively, the device manager can receive a user input to add one or more of the storage volumes of the removable storage device to the library of storage locations for the computing device and, responsive to the user input, initiate to determine whether the storage volumes are configured on the removable storage device and whether at least one of the storage volumes is associated with the user. The device manager, or other device component, can also detect a default action associated with the storage volume when the removable storage device is connected to the computing device. The default action is also detectable from the storage volume of the removable storage device by a device manager or other device component of another computing device when the removable storage device is connected to the other computing device.

### BRIEF DESCRIPTION OF THE DRAWINGS

Embodiments of removable storage device identity and configuration information are described with reference to the following Figures. The same numbers may be used throughout to reference like features and components that are shown in the Figures:

FIG. 1 illustrates an example system in which embodiments of removable storage device identity and configuration information can be implemented.

FIG. 2 illustrates example method(s) of removable storage device identity and configuration information in accordance with one or more embodiments.

FIG. 3 illustrates example method(s) of removable storage device identity and configuration information in accordance with one or more embodiments.

FIG. 4 illustrates an example system with an example device that can implement embodiments of removable storage device identity and configuration information.

### DETAILED DESCRIPTION

Embodiments of removable storage device identity and configuration information are described and may be implemented by any type of device or system that utilizes removable and/or other types of storage devices. A removable storage device can be associated with one or more different users, and preferences of each user can be stored on the removable storage device. Additionally, the removable storage device can be connected or inserted in various computing devices, and actions can be initiated by a computing device based on the preferences that are stored on the removable storage device and that correspond to a particular user.

In implementations, storage volumes of a removable storage device can be distinctly identified as the same storage volumes across various, different computing devices. The storage devices can also be differentiated from other storage devices that may have a same name or other identifier. A removable storage device and any storage volumes that are designated on the removable storage device will be identified the same on any computing device that the removable storage device is connected or inserted into.

While features and concepts of removable storage device identity and configuration information can be implemented in any number of different devices, systems, networks, environments, and/or configurations, embodiments of removable storage device identity and configuration information are described in the context of the following example devices, systems, and methods.

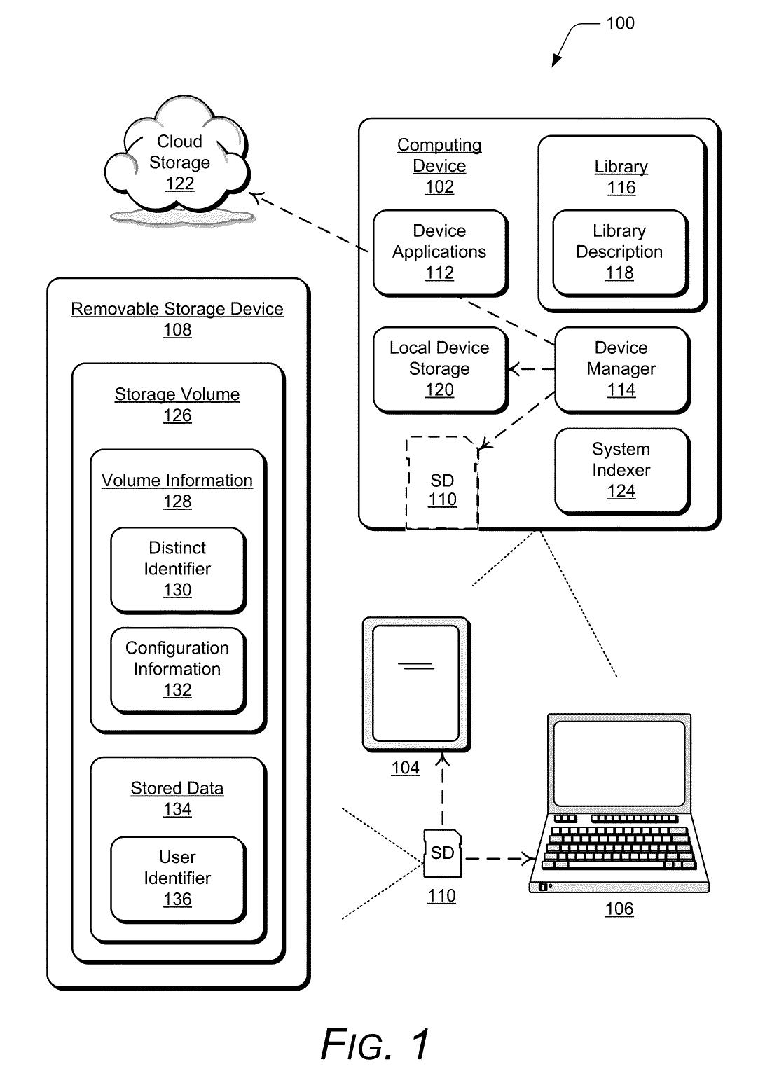

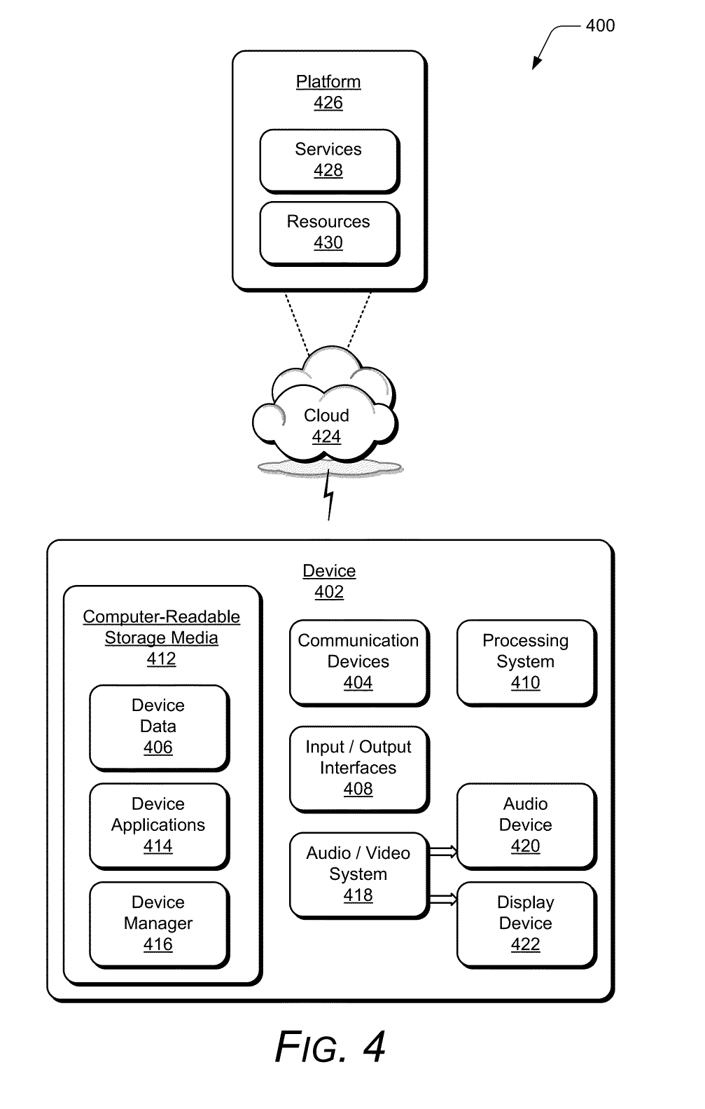

FIG. 1 illustrates an example system 100 in which embodiments of removable storage device identity and configuration information can be implemented. The system 100 includes an example computing device 102 that may be any one or combination of a wired or wireless device, such as a mobile phone, tablet, computing, communication, entertainment, gaming, media playback, and/or other type of device that may be associated with a user. For example, a user may have several devices, such as a mobile phone, a tablet device 104, a laptop computer 106, as well as other types of computing devices. Any of the computing devices described herein can be implemented with various components, such as a processing system and memory, as well as any number and combination of differing components as further described with reference to the example device shown in FIG. 4.

The example system 100 also includes a removable storage device 108 that is representative of any type of non-volatile memory, such as any type of a secure digital (SD) card 110 that may be utilized with multiple computing devices. For example, a user can insert and use the SD card 110 with the tablet device 104, remove the SD card, and then insert and use the SD card with the laptop computer 106. The computing device 102 is also shown with the SD card 110 inserted as an example of the removable storage device 108 that can be utilized as extended data storage of the computing device. The removable storage device 108 may be implemented as any type of memory devices, such as the SD card 110 or a USB memory that is connected to a computing device via the bus structure.

The computing device 102 includes any type of user and/or device applications 112 on the computing device that receive, manipulate, operate with, and/or generate data. For example, the tablet device 104 and/or the laptop computer 106 may include any type of applications for communication (e.g., email and text messaging), media playback (e.g., videos and music), document generation (e.g., word processing and database files), Web browsing, and any other type of user and/or device applications. A removable storage device 108, such as the SD card 110, is accessible by the device applications 112 when connected or inserted into the computing device 102, and the removable storage device maintains application data for the device applications.

The computing device 102 also includes a device manager 114 that can be implemented as a software application (e.g., executable instructions) stored on computer-readable storage media, such as any suitable memory device or electronic data storage. The device manager 114 can be executed with a processing system of the computing device 102 to manage a library 116 of storage locations that are accessible by the device applications 112, and maintain application data for the device applications. Generally, the device applications write application data to the storage locations and/or read the application data from the storage locations. In implementations, the device manager 114 may encompass any components and/or features of a file manager, operating system, device controller, and/or other components of a system or device that may coordinate to implement the features of the device manager as described herein to implement embodiments of removable storage device identity and configuration information.

The library 116 includes a library description 118 of the storage locations, which in this example, include the SD card 110 (e.g., a removable storage device), local device storage 120 of the computing device, and/or cloud storage 122, such as any Web-based data hosting service (also referred to as cloud-based, or “in the cloud”). The local device storage 120 of the computing device 102 can be any type of computer-readable storage media as described with reference to the example device shown in FIG. 4. The library description 118 is a virtualized view of the storage locations that are accessible by the device applications 112 on the computing device 102. The computing device 102 may also include a system indexer 124 that indexes the library 116 of storage locations.

Any of the devices described herein can communicate via a network, such as for data communication between the computing device 102 and the cloud storage 122, and the network can be implemented to include a wired and/or a wireless network. The network can also be implemented using any type of network topology and/or communication protocol, and can be represented or otherwise implemented as a combination of two or more networks, to include IP-based networks and/or the Internet. The network may also include mobile operator networks that are managed by a mobile network operator and/or other network operators, such as a communication service provider, mobile phone provider, and/or Internet service provider.

In the example system 100, the removable storage device 108 includes one or more areas of storage volume 126, which can each be distinctly identified as a separate storage location in the library 116 of storage locations on the computing device 102. Additionally, multiple storage locations from one storage volume 126 can be identified in the library 116 of storage locations on the computing device. Although only one storage volume is shown on the removable storage device 108 in this example, the removable storage device may include multiple storage volumes that are each distinctly identified as separate storage volumes on the removable storage device. A storage volume may also be configured as a logical storage volume on a removable storage device, or as a logical storage volume that encompasses more than one removable storage device. For example, a logical storage volume may include multiple storage devices, such as in a RAID system (a redundant array of independent disks or devices), rather than a single removable storage device having multiple storage volumes as shown and described.

Each storage volume 126 on the removable storage device 108 includes volume information 128, such as a distinct identifier 130 of the storage volume 126 and/or configuration information 132 of the storage volume. The configuration information can include preferences that apply to the storage volume 126, such as for the application data that is maintained by the storage volume. For example, the configuration information that is associated with a particular storage volume 126 can designate how to start and/or use the application data that is maintained by the storage volume, and this will be universal across the various computing devices when the removable storage device is connected to a computing device. This technique differs from the conventional aspect of each computing device having to store the configuration information for each of the different removable storage devices that may be connected to a computing device.

Each storage volume 126 on the removable storage device 108 also includes stored data 134, such as associated user and/or application data that is accessed by the device applications when the removable storage device is connected to a computing device. The stored data 134 can also include a user identifier 136 that distinctly identifies the user who is associated with the user data. Alternatively or in addition, the configuration information 132 can include user-identifying information. The user identifier 136 associates the storage volume 126 on the removable storage device 108 with a particular user of the stored data 134, and the user identifier can include a user account identifier, such as a login name or other credential that is unique to the user across all of the various computing devices that may be used by the user.

A user can connect a removable storage device, such as the SD card 110, to any of the computing devices, and then access a setup or configuration interface to select or initiate using the removable storage device as an extended storage location for different file types that are associated with the device applications 112 of a computing device, such as for default save locations of the device applications. The device manager 114 on the corresponding computing device can then set up a folder structure in the library 116 of storage locations on the computing device, and also write the configuration information 132 to the storage volumes 126 on the removable storage device.

The device manager is implemented to identify storage volumes 126 that are configured on the removable storage device 108 while the removable storage device is connected to the computing device 102. A storage volume 126 may be previously identified as a storage location for one of the other computing devices when the removable storage device is connected to another computing device. The device manager 114 can also determine whether at least one of the storage volumes 126 is associated with a user of the computing device, such as based on the user identifier 136 and/or the configuration information 132, and then add the storage volume 126 to the library 116 of storage locations for the computing device at the identified storage location that is the same for the other computing devices.

Each of the storage volumes 126 on the removable storage device 108 are distinctly identified as separate storage volumes, and may have been previously configured on the removable storage device and associated with a user while the removable storage device is connected to any of the other computing devices. Alternatively, the device manager 114 is implemented to generate the distinct identifier 130 for each of the storage volumes on the removable storage device if the storage volumes have not been previously identified, and write each of the distinct identifiers to the respective storage volumes on the removable storage device. The device manager 114 can also associate one or more of the storage volumes on the removable storage device 108 with the user of the computing device, and write the configuration information 132 for each of the storage volumes to the removable storage device.

The system indexer 124 can be implemented to write a search index (e.g., as part of the configuration information 132) for each of the storage volumes 126 on the removable storage device 108. The search index is then accessible by the system indexer 124 to search the application data (e.g., the associated stored data 134) while the removable storage device is connected to the computing device. The search index is also accessible by a system indexer of another computing device while the removable storage device is connected to the other computing device.

In implementations, the device manager 114 can detect the removable storage device 108 and automatically initiate to determine whether the storage volumes 126 are configured on the removable storage device and whether at least one of the storage volumes is associated with the user of the computing device. Alternatively, the device manager 114 can receive a user input to add one or more of the storage volumes of the removable storage device to the library 116 of storage locations for the computing device 102 and, responsive to the user input, initiate to determine whether the storage volumes are configured on the removable storage device and whether at least one of the storage volumes is associated with the user. The device manager 114, or other device component, can also detect a default action associated with the storage volume when the removable storage device is connected to the computing device. The default action is also detectable from the storage volume of the removable storage device by a device manager or other device component of another computing device when the removable storage device is connected to the other computing device.

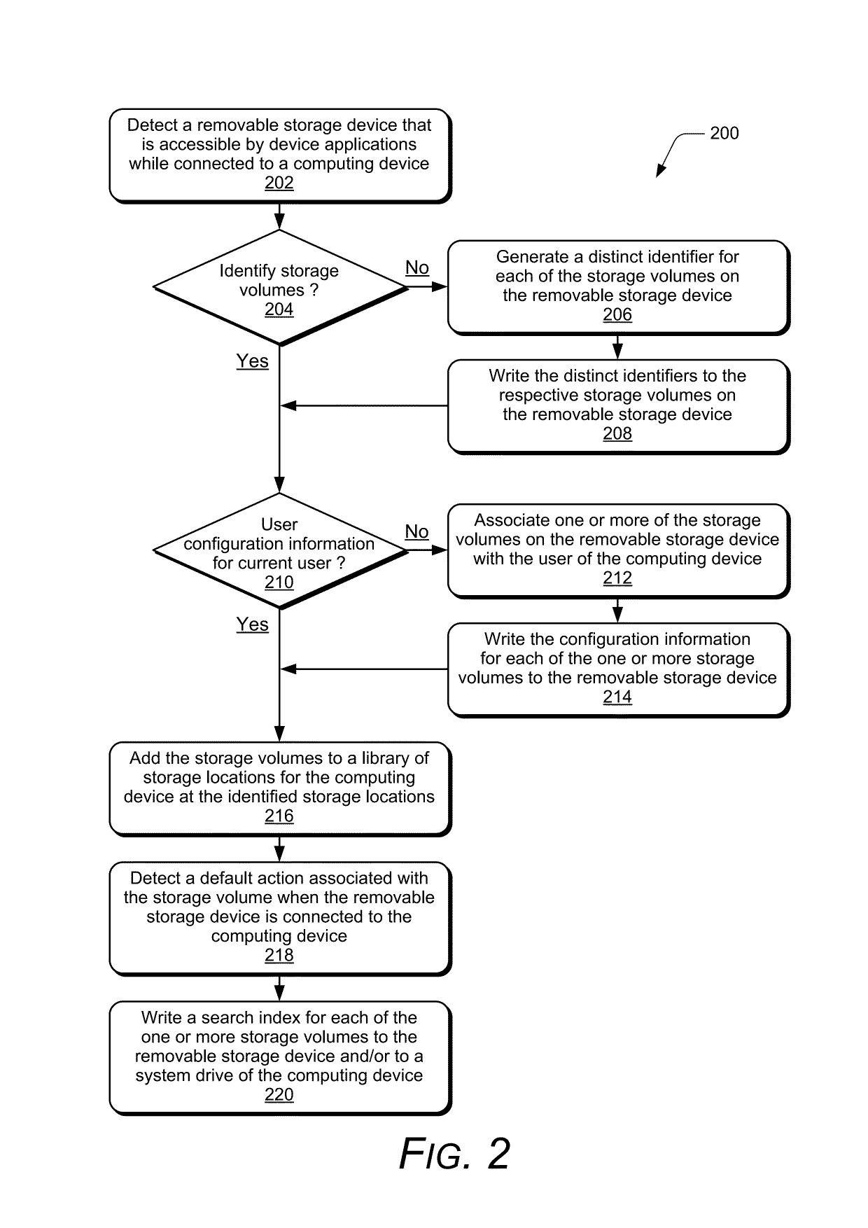

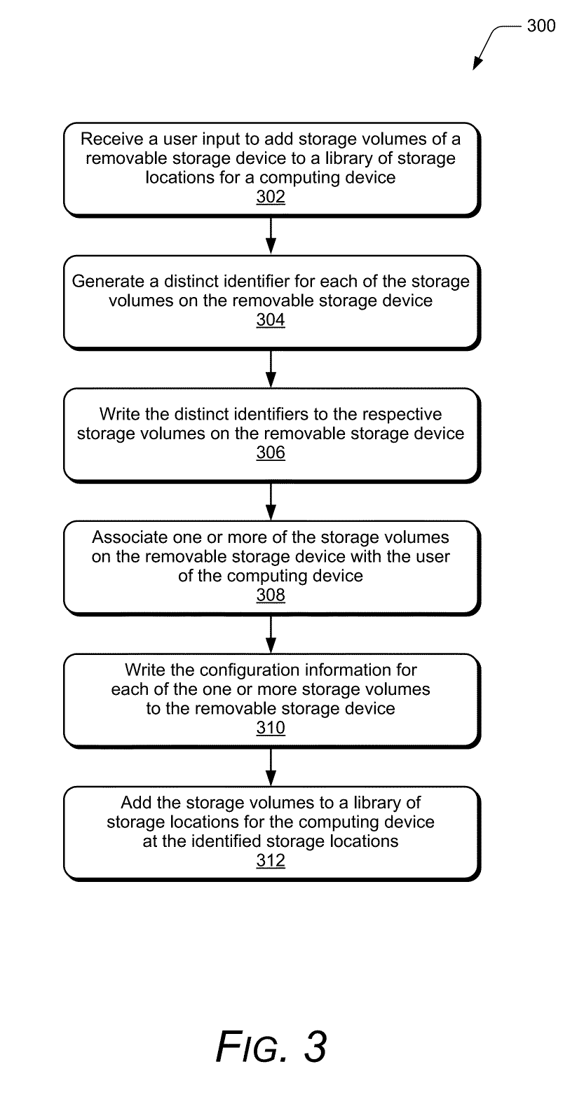

Example methods 200 and 300 are described with reference to respective FIGS. 2 and 3 in accordance with one or more embodiments of removable storage device identity and configuration information. Generally, any of the services, components, modules, methods, and operations described herein can be implemented using software, firmware, hardware (e.g., fixed logic circuitry), manual processing, or any combination thereof. The example methods may be described in the general context of executable instructions stored on computer-readable storage media that is local and/or remote to a computer processing system, and implementations can include software applications, programs, functions, and the like.

FIG. 2 illustrates example method(s) 200 of removable storage device identity and configuration information, and is generally described with reference to a device manager. The order in which the method is described is not intended to be construed as a limitation, and any number or combination of the method operations can be performed in any order to implement a method, or an alternate method.

At 202, a removable storage device is detected, and is accessible by device applications while connected to a computing device. For example, the device manager 114 implemented at the computing device 102 (FIG. 1) detects the removable storage device 108 (e.g., implemented as the SD card 110) that maintains application data for the device applications 112 of the computing device. A first instance of a device application 112 on the computing device 102 can access the application data that is maintained by the storage volume 126 of the removable storage device 108 at the identified storage location, and a second instance of the device application on another computing device can access the application data at the identified storage location while the removable storage device 108 is connected to the other computing device.

At 204, a determination is made as to whether one or more storage volumes on the removable storage device are identified. For example, the device manager 114 identifies one or more of the storage volumes 126 on the removable storage device 108. Each of the storage volumes may be previously identified on the removable storage device by another computing device, such as the tablet device 104 or the laptop computer 106, and identified as separate storage locations for another computing device when the removable storage device is connected to the other computing device. The one or more storage volumes of the removable storage device may also have been associated with a user while the removable storage device is connected to the other computing device.

If a storage volume is not identified on the removable storage device (i.e., “no” from 204), then a distinct identifier is generated for each of the storage volumes on the removable storage device at 206, and the distinct identifiers are written to the respective storage volumes on the removable storage device at 208. For example, the device manager 114 generates a distinct identifier 130 for each of the storage volumes 126 on the removable storage device 108, and then writes the distinct identifiers to the respective storage volumes on the removable storage device.

If one or more storage volumes are identified on the removable storage device (i.e., “yes” from 204), or continuing the method from 208, a determination is made as to whether a storage volume includes user configuration information associated with the current user at 210. For example, the device manager 114 determines whether one or more storage volumes 126 of the removable storage device 108 include user configuration information that is associated with the current user.

If the storage volumes do not include configuration information for a current user (i.e., “no” from 210), then one or more of the storage volumes on the removable storage device are associated with the user of the computing device at 212, and the configuration information is written to the respective storage volumes on the removable storage device at 214. For example, the device manager 114 associates the storage volumes 126 of the removable storage device 108 with the user of the computing device 102, and then writes the configuration information 132 to the respective storage volumes on the removable storage device. In implementations, the device manager 114 creates a new folder structure that is associated with the user on a storage volume of the removable storage device, and then links the new folder structure locations of the storage volume to the current user libraries on the computing device.

If the storage volumes do include configuration information for a current user (i.e., “yes” from 210), or continuing the method from 214, then the one or more storage volumes are added to a library of storage locations for the computing device at the identified storage locations at 216. For example, the device manager 114 adds the storage volumes 126 to the library 116 of storage locations for the computing device at the identified storage locations (e.g., as identified by the library description 118).

At 218, a default action associated with a storage volume is detected when the removable storage device is connected to the computing device. For example, the device manager 114 or other device component detects a default action associated with the storage volume 126 when the removable storage device 108 is connected to the computing device 102, and the default action is also detectable from the storage volume when the removable storage device is connected to another of the computing devices, such as the tablet device 104 and/or the laptop computer 106.

At 220, a search index for each of the storage volumes is written to the removable storage device and/or to a system drive of the computing device. For example, the system indexer 124 writes a search index (e.g., as part of the configuration information 132) for each of the storage volumes 126 to the removable storage device 108 and/or to a system drive of the computing device. A search index for a storage volume 126 is then accessible by the system indexer 124 to search the stored data 134 while the removable storage device is connected to the computing device, and the search index is accessible while the removable storage device is connected to another one of the computing devices.

FIG. 3 illustrates example method(s) 300 of removable storage device identity and configuration information, and is generally described with reference to a device manager. The order in which the method is described is not intended to be construed as a limitation, and any number or combination of the method operations can be performed in any order to implement a method, or an alternate method.

At 302, a user input is received to add storage volumes of a removable storage device to a library of storage locations for a computing device. For example, the device manager 114 implemented at the computing device 102 (FIG. 1) receives a user input to add one or more of the storage volumes 126 of the removable storage device 108 to the library 116 of storage locations for the computing device 102. A user can connect a removable storage device, such as the SD card 110, to any of the computing devices, and then access a setup or configuration interface to select or initiate using the removable storage device as an extended storage location for different file types that are associated with the device applications 112 of a computing device, such as for default save locations of the device applications. The device manager 114 on the corresponding computing device can then set up a folder structure in the library 116 of storage locations on the computing device, and also write the configuration information 132 to the respective storage volumes 126 on the removable storage device.

At 304, a distinct identifier is generated for each of the storage volumes on the removable storage device and, at 306, the distinct identifiers are written to the respective storage volumes on the removable storage device. For example, the device manager 114 generates a distinct identifier 130 for each of the storage volumes 126 on the removable storage device 108, and then writes the distinct identifiers to the respective storage volumes on the removable storage device.

At 308, one or more of the storage volumes on the removable storage device are associated with the user of the computing device and, at 310, the configuration information is written to the respective storage volumes on the removable storage device at 214. For example, the device manager 114 associates the storage volumes 126 of the removable storage device 108 with the user of the computing device 102, and then writes the configuration information 132 to the respective storage volumes on the removable storage device.

At 312, the one or more storage volumes are added to a library of storage locations for the computing device at the identified storage locations. For example, the device manager 114 adds the storage volumes 126 to the library 116 of storage locations for the computing device at the identified storage locations (e.g., as identified by the library description 118).

FIG. 4 illustrates an example system 400 that includes an example device 402, which can implement embodiments of removable storage device identity and configuration information. The example device 402 can be implemented as any of the devices described with reference to the previous FIGS. 1-3, such as any type of client device, mobile phone, tablet, computing, communication, entertainment, gaming, media playback, and/or other type of device. For example, the computing device 102, tablet device 104, and/or laptop computer 106 shown in FIG. 1 may be implemented as the example device 402.

The device 402 includes communication devices 404 that enable wired and/or wireless communication of device data 406, such as any type of application data that can be stored or maintained with a storage device at an identified storage location. Additionally, the device data can include any type of audio, video, and/or image data. The communication devices 404 can also include transceivers for cellular phone communication and for network data communication.

The device 402 also includes input/output (I/O) interfaces 408, such as data network interfaces that provide connection and/or communication links between the device, data networks, and other devices. The I/O interfaces can be used to couple the device to any type of components, peripherals, and/or accessory devices. The I/O interfaces also include data input ports via which any type of data, media content, and/or inputs can be received, such as user inputs to the device, as well as any type of audio, video, and/or image data received from any content and/or data source.

The device 402 includes a processing system 410 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 402 may further include any type of a system bus or other data and command transfer system that couples the various components within the device. A system bus can include any one or combination of different bus structures and architectures, as well as control and data lines.

The device 402 also includes computer-readable storage media 412, such as data storage devices that can be accessed by a computing device, and that provide persistent storage of data and executable instructions (e.g., software applications, programs, functions, and the like). Examples of computer-readable storage media include volatile memory and non-volatile memory, fixed and removable media devices (e.g., removable storage devices), and any suitable memory device or electronic data storage that maintains data for computing device access. The computer-readable storage media can include various implementations of random access memory (RAM), read-only memory (ROM), flash memory, and other types of storage media in various memory device configurations.

The computer-readable storage media 412 provides storage of the device data 406 and various device applications 414, such as an operating system that is maintained as a software application with the computer-readable storage media and executed by the processing system 410. In this example, the device applications also include a device manager 416 that implements embodiments of removable storage device identity and configuration information, such as when the example device 402 is implemented as the computing device 102 shown in FIG. 1. An example of the device manager 416 is the device manager 114 implemented by the computing device 102, as described with reference to FIGS. 1-3.

The device 402 also includes an audio and/or video system 418 that generates audio data for an audio device 420 and/or generates display data for a display device 422. The audio device and/or the display device include any devices that process, display, and/or otherwise render audio, video, display, and/or image data. In implementations, the audio device and/or the display device are integrated components of the example device 402. Alternatively, the audio device and/or the display device are external, peripheral components to the example device.

In embodiments, at least part of the techniques described for removable storage device identity and configuration information may be implemented in a distributed system, such as over a “cloud” 424 in a platform 426. The cloud 424 includes and/or is representative of the platform 426 for services 428 and/or resources 430. The platform 426 abstracts underlying functionality of hardware, such as server devices (e.g., included in the services 428) and/or software resources (e.g., included as the resources 430), and connects the example device 402 with other devices, servers, etc.

The resources 430 may include applications and/or data that can be utilized while computer processing is executed on servers that are remote from the example device 402. Additionally, the services 428 and/or the resources 430 may facilitate subscriber network services, such as over the Internet, a cellular network, or Wi-Fi network. The platform 426 may also serve to abstract and scale resources to service a demand for the resources 430 that are implemented via the platform, such as in an interconnected device embodiment with functionality distributed throughout the system 400. For example, the functionality may be implemented in part at the example device 402 as well as via the platform 426 that abstracts the functionality of the cloud 424.

Although embodiments of removable storage device identity and configuration information have been described in language specific to features and/or methods, the appended claims are not necessarily limited to the specific features or methods described. Rather, the specific features and methods are disclosed as example implementations of removable storage device identity and configuration information.

1. A computing device, comprising:
a removable storage device that is accessible by device applications while connected to the computing device, the removable storage device configured to maintain application data for the device applications;
a processing system to implement a device manager that is configured to:
identify one or more storage volumes on the removable storage device;
determine whether at least one of the storage volumes is associated with a user of the computing device if the storage volume is identified on the removable storage device, the storage volume identified as a storage location for another computing device when the removable storage device is connected to the other computing device; and
add the storage volume to a library of storage locations for the computing device at the identified storage location that is the same for the other computing device.

2. A computing device as recited in claim 1, wherein each of the one or more storage volumes are distinctly identified as separate storage volumes on the removable storage device.

3. A computing device as recited in claim 1, wherein the one or more storage volumes are previously configured on the removable storage device and associated with the user while the removable storage device is connected to the other computing device.

4. A computing device as recited in claim 1, wherein the device manager is configured to:
generate a distinct identifier for each of the one or more storage volumes on the removable storage device if the one or more storage volumes have not been previously identified; and
write each of the distinct identifiers to the respective one or more storage volumes on the removable storage device.

5. A computing device as recited in claim 4, wherein the device manager is configured to:
associate the one or more storage volumes with the user of the computing device; and
write configuration information for each of the one or more storage volumes to the removable storage device.

6. A computing device as recited in claim 5, further comprising a system indexer configured to write a search index for each of the one or more storage volumes to the removable storage device, the search index accessible by the system indexer to search the application data while the removable storage device is connected to the computing device, and the search index accessible while the removable storage device is connected to the other computing device.

7. A computing device as recited in claim 1, wherein the device manager is configured to one of:
detect the removable storage device and automatically said identify the one or more storage volumes on the removable storage device and determine whether the at least one storage volume is associated with the user; or
receive a user input to add one or more of the storage volumes of the removable storage device to the library of storage locations for the computing device and, responsive to the user input, said identify the one or more storage volumes on the removable storage device and determine whether the at least one storage volume is associated with the user.

8. A computing device as recited in claim 1, wherein:
a first instance of a device application on the computing device is configured to access the application data that is maintained by the storage volume of the removable storage device at the identified storage location; and
a second instance of the device application on the other computing device is configured to access the application data at the identified storage location while the removable storage device is connected to the other computing device

9. A computing device as recited in claim 1, wherein the device manager is configured to detect a default action associated with the storage volume when the removable storage device is connected to the computing device, the default action also detectable from the storage volume when the removable storage device is connected to the other computing device.

10. A method, comprising:
detecting a removable storage device that is accessible by device applications while connected to a computing device, the removable storage device configured to maintain application data for the device applications;
determining whether one or more storage volumes are already identified on the removable storage device, at least one of the storage volumes identified as a storage location for another computing device when the removable storage device is connected to the other computing device; and
adding the storage volume to a library of storage locations for the computing device at the identified storage location that is the same for the other computing device.

11. A method as recited in claim 10, further comprising:
determining whether at least one of the storage volumes is associated with a user of the computing device if the storage volume is already identified on the removable storage device.

12. A method as recited in claim 10, further comprising:
generating a distinct identifier for each of the one or more storage volumes on the removable storage device if the one or more storage volumes have not been previously identified; and
writing each of the distinct identifiers to the respective one or more storage volumes on the removable storage device.

13. A method as recited in claim 10, further comprising:
associating the one or more storage volumes with a user of the computing device; and
writing configuration information for each of the one or more storage volumes to the removable storage device.

14. A method as recited in claim 10, further comprising:
writing a search index for each of the one or more storage volumes to the removable storage device, the search index accessible by a system indexer to search the application data while the removable storage device is connected to the computing device, and the search index accessible while the removable storage device is connected to the other computing device.

15. A method as recited in claim 10, further comprising:
receiving a user input to add one or more of the storage volumes of the removable storage device to the library of storage locations for the computing device.

16. A method as recited in claim 10, further comprising:
detecting a default action associated with the storage volume when the removable storage device is connected to the computing device, the default action also detectable from the storage volume when the removable storage device is connected to the other computing device.

17. A removable storage device, comprising:
one or more storage volumes configured to maintain application data that is accessible by device applications while the removable storage device is connected to a computing device;
distinct identifiers that each distinctly identify a respective storage volume of the removable storage device, the distinct identifiers generated by a device manager of the computing device while the removable storage device is connected; and
configuration information for each of the one or more storage volumes, the configuration information for a storage volume including an identified storage location of the storage volume while connected to the computing device, the identified storage location configured the same when the removable storage device is connected to another computing device.

18. A removable storage device as recited in claim 17, further comprising distinct user identifiers that each distinctly associate a respective storage volume of the removable storage device with one or more users of the computing device, the distinct user identifiers generated by the device manager of the computing device while the removable storage device is connected.

19. A removable storage device as recited in claim 17, further comprising a search index for each of the one or more storage volumes of the removable storage device, the search index accessible by a system indexer to search the application data while the removable storage device is connected to the computing device, and the search index accessible while the removable storage device is connected to the other computing device.

20. A removable storage device as recited in claim 17, wherein the configuration information for the storage volume includes a default action associated with the storage volume when the removable storage device is connected to the computing device, the default action also detectable from the storage volume when the removable storage device is connected to the other computing device.
